(19) United States
(12) Patent Application Publication
(10) Pub. No.: US 2007/0085770 A1
(43) Pub. Date: Apr. 19, 2007

(54) Plasma display device and a driving method thereof

(76) Inventors: Byung-Gwon Cho, Chunan-si (KR); Myoung-Kyu Lee, Chunan-si (KR)

Correspondence Address: CHRISTIE, PARKER & HALE, LLP, PO BOX 7068, PASADENA, CA, 91109-7068, US

(21) Appl. No.: 11/517,140

(22) Filed: Sep. 6, 2006

(30) Foreign Application Priority Data
Oct. 17, 2005 (KR) 10-2005-0097697

(51) Int. Cl. G09G 3/28

(52) U.S. Cl. 345/67

(57) ABSTRACT

A plasma display device and a driving method thereof are provided. A sustain pulse is applied to a scan electrode while biasing a sustain electrode at a predetermined voltage during a sustain period. A first sustain pulse having a first magnitude of voltage is applied at lease once to the scan electrode during a first part of the sustain period, and a second sustain pulse and a third sustain pulse are alternately applied to the scan electrode during a second part of the sustain period. The second sustain pulse has a voltage of a second magnitude that is smaller than the first magnitude, and the third sustain pulse has a voltage of a third magnitude that is larger than the second magnitude.

### CROSS-REFERENCE TO RELATED APPLICATION

This application claims priority to and the benefit of Korean Patent Application No. 10-2005-0097697 filed in the Korean Intellectual Property Office on Oct. 17, 2005, the entire content of which is incorporated herein by reference.

### BACKGROUND OF THE INVENTION

(a) Field of the Invention

The present invention relates to a plasma display device and a driving method thereof.

(b) Description of the Related Art

A plasma display device is a display device using a plasma display panel (PDP) which uses plasma generated by gas discharge to display characters or images. Such a PDP includes a plurality of discharge cells arranged in a matrix pattern.

One frame of such a plasma display device is divided into a plurality of subfields having weight values, and each subfield includes a reset period, an address period, and a sustain period. The reset period is a period for resetting the state of discharge cells so that an address discharge may be stably performed, and the address period is a period for selecting discharge cells to be turned on and discharge cells not to be turned on. In addition, the sustain period is a period for applying a sustain discharge to the addressed cells so as to actually display images.

In order to perform the above-noted operations, sustain pulses are alternately applied to the scan electrodes and the sustain electrodes during the sustain period, and reset waveforms and scan waveforms are applied to the scan electrodes during the reset period and the address period, respectively. Therefore, a scan driving board for driving the scan electrodes and a sustain driving board for driving the sustain electrodes are separately needed, and in this case, a problem of mounting the driving boards on a chassis base may arise, and the cost for the driving boards may be increased due to the separate driving boards.

On the other hand, when a driving circuit formed on a sustain driving board is coupled to a scan driving board to reduce the cost of the driving boards, the length of a wire (or a conductive pattern) connecting the scan driving board and the sustain electrode can be extended. Consequently, the sustain pulses applied at the sustain electrode are distorted at the voltage variation point of the sustain pulse due to parasitic components formed on the wire.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a plasma display device that removes a sustain driving board for driving a sustain electrode.

In addition, embodiments of the present invention provide a driving method of a plasma display device that prevents misfiring and a weak discharge during a sustain period.

An exemplary embodiment according to the present invention includes a method for driving a plasma display device during a plurality of subfields divided from a frame, the plasma display device having a plurality of first electrodes and a plurality of second electrodes. The driving method includes, in a sustain period of at least one subfield among the plurality of subfields, applying at least one of first sustain pulses having a voltage of first magnitude to the second electrode during a first part of the sustain period while biasing the first electrode at a first voltage, and alternately applying a second sustain pulse and a third sustain pulse to the second electrode during a second part of the sustain period while biasing the first electrode at the first voltage. The second sustain pulse has a voltage of second magnitude that is smaller than the voltage of first magnitude, and the third sustain pulse has a voltage of third magnitude that is greater than the voltage of second magnitude. At this time, a width of the first sustain pulse may be greater than that of the second sustain pulse or the third sustain pulse. In addition, a voltage of the first sustain pulse may be higher than that of the second sustain pulse.

The present invention also provides a plasma display device including a PDP (plasma display panel) and a driver. The PDP includes a plurality of the first electrodes and a plurality of the second electrodes, and the driver applies a sustain pulse to the second electrodes while the first electrode is biased at a first voltage during a sustain period of at least one subfield. In addition, the driver applies a first sustain pulse having a first pulse width to the second electrode at least once during a first part of the sustain period, and the driver-alternately applies a second sustain pulse and a third sustain pulse during a second part of the sustain period. The second sustain pulse has a second pulse width that is smaller than the first pulse width and a second voltage that is lower than the first voltage, and the third sustain pulse has a third pulse width that is smaller than the first pulse width and a third voltage that is higher than the first voltage. In addition, a magnitude of the third voltage is smaller than a magnitude of the second voltage. A voltage of the first sustain pulse may be higher than the third voltage.

### BRIEF DESCRIPTION OF THE DRAWINGS

FIG. 1 is an exploded perspective view of a plasma display device according to an exemplary embodiment of the present invention.

FIG. 2 is an electrode arrangement diagram of a PDP according to an exemplary embodiment of the present invention.

FIG. 3 is a schematic plan view of a chassis base according to an exemplary embodiment of the present invention.

FIG. 4 is a driving waveform diagram of a plasma display device according to a first exemplary embodiment of the present invention.

FIG. 5 is a driving waveform diagram of a plasma display device according to a second exemplary embodiment of the present invention.

FIG. 6 is a driving waveform diagram of a plasma display device according to a third exemplary embodiment of the present invention.

FIG. 7 is a driving waveform diagram of a plasma display device according to a fourth exemplary embodiment of the present invention.

### DETAILED DESCRIPTION

In the following description, wall charges refer to charges formed and accumulated on a wall (e.g., a dielectric layer) close to an electrode of a discharge cell. Although the wall charges do not actually touch the electrodes, the wall charge will be described as being “formed” or “accumulated” on the electrode. The term “wall voltage” refers to a potential formed on a wall of a cell due to the wall charges.

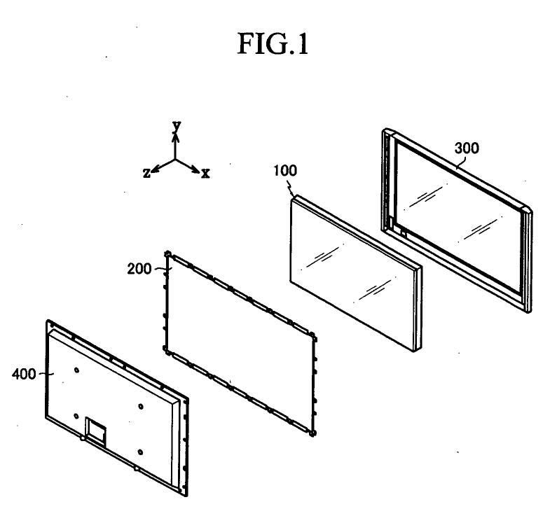

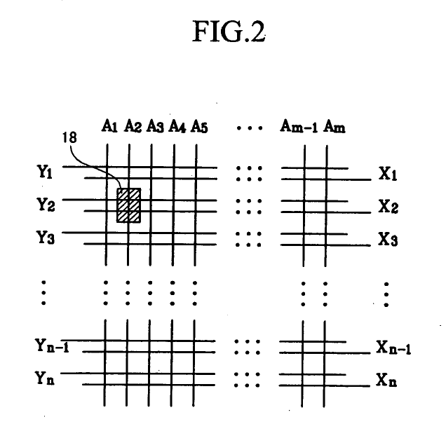

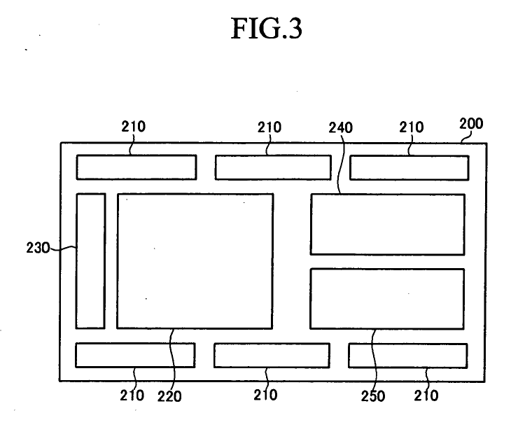

A schematic structure of a plasma display device according to an exemplary embodiment of the present invention will be described with reference to FIG. 1, FIG. 2, and FIG. 3.

FIG. 1 is an exploded perspective view showing a plasma display device according to an exemplary embodiment of the present invention; FIG. 2 is an electrode arrangement diagram showing a PDP according to an exemplary embodiment of the present invention; and FIG. 3 is a plan view schematically showing a chassis base according to an exemplary embodiment of the present invention.

As shown in FIG. 1, a plasma display device according to an exemplary embodiment of the present invention include a PDP 100, a chassis base 200, a front case 300, and a rear case 400. The chassis base 200 is located opposite to an image display side of the PDP 100 and is combined with the PDP 100. Being respectively located to the front of the PDP 100 and the rear of the chassis base 200, the front and rear cases 300 and 400 are combined with the PDP 100 and the chassis base 200 to form a plasma display device.

As shown in FIG. 2, the PDP 100 according to an exemplary embodiment of the present invention includes a plurality of address electrodes A1-Am extending in a column direction and a plurality of scan electrodes Y1-Yn and sustain electrodes X1-Xn each extending in a row direction. The sustain electrodes X1-Xn are formed in respective correspondence to the scan electrodes Y1-Yn. The address electrodes A1-Am perpendicularly cross the directions of the scan electrodes Y1-Yn and sustain electrodes X1-Xn. Discharge spaces are formed at regions where the address electrodes A1-Am cross over the sustain and scan electrodes X1-Xn and Y1-Yn, and such discharge spaces form discharge cells 18. FIG. 1 and FIG. 2 show an exemplary structure of the PDP 100, and the PDP 100 may have different configurations to which the driving waveform described below can be applied.

As shown in FIG. 3, driving boards 210, 220, 230, 240, and 250 for driving the PDP 100 are formed on the chassis base 200. Address buffer boards 210, shown in upper and lower portions of the chassis base 200, may be formed as a single board or a plurality of boards. It is notable that FIG. 3 exemplarily illustrates the chassis base of a plasma display device driven by a dual driving method. In the case of a plasma display device driven by a single driving method, the address buffer board 210 is located at either the upper portion or the lower portion of the chassis base 200. The address buffer board 210 receives an address driving control signal from an image processing and controlling board 240, and applies a voltage for selecting turn-on discharge cells (i.e., discharge cells to be turned on) to the address electrodes A1-Am.

A scan driving board 220 is located to the left on the chassis base 200, and is electrically coupled with the scan electrodes Y1-Yn through a scan buffer board 230. The sustain electrodes X1-Xn are biased at a predetermined voltage. The scan buffer board 230 applies a voltage to the scan electrodes Y1-Yn for sequential selection thereof during an address period. The scan driving board 220 receives driving signals from the image processing and controlling board 240, and provides the driving voltages for the scan electrodes Y1-Yn to the scan buffer board 230. In FIG. 3, the scan driving board 220 and the scan buffer board 230 are shown to be located to the left on the chassis base 200, however, they may be located to the right. In addition, the scan buffer board 230 may be integrally formed with the scan driving board 220.

The image processing and controlling board 240, after externally receiving image signals, generates control signals for driving the address electrodes A1-Am and control signals for driving the scan and sustain electrodes Y1-Yn and X1-Xn, and respectively applies them to the address buffer board 210 and the scan driving board 220.

A power supply board 250 supplies electric power for driving the plasma display device. The image processing and controlling board 240 and the power supply board 250 may be located at a central area of the chassis base 200.

The address buffer board 210, the scan driving board 220, and the scan buffer board 230 form a driver for driving the address electrodes A1-Am and scan electrodes Y1-Yn. The image processing and controlling board 240 forms a controller for controlling the driver, and the power supply board 500 forms a power source for supplying power to the driver and the controller.

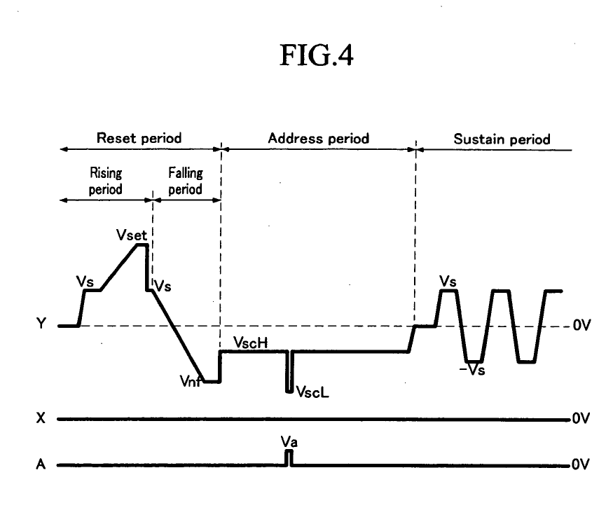

Hereinafter, a driving waveform of a plasma display device according to a first embodiment of the present invention will be described with reference to FIG. 4.

FIG. 4 is a driving waveform diagram of a plasma display device according to the first embodiment of the present invention. In the following description, the driving waveform applied to a scan electrode (hereinafter called a Y electrode), a sustain electrode (hereinafter called an X electrode), and an address electrode (hereinafter called an A electrode) is described in connection with only one cell, for better comprehension and convenience of description. In addition, in the driving waveform shown in FIG. 4, the voltage applied to the Y electrode is supplied from the scan driving board 220 and the scan buffer board 230, and the voltage applied to the A electrode is supplied from the address buffer board 210. Since the X electrode is biased at a reference voltage (refer to ground voltage in FIG. 4), the voltage applied to the X electrode is not described in further detail.

Referring to FIG. 4, a subfield includes a reset period, an address period, and a sustain period, wherein the reset period includes a rising period and a falling period.

During the rising period of the reset period, the voltage of the Y electrode is gradually increased from a voltage Vs to a voltage Vset while maintaining the A electrode and X electrode at the reference voltage (0V in FIG. 4). FIG. 4 illustrates that the voltage of the Y electrode increases according to a ramp pattern. While the voltage of the Y electrode increases, a weak discharge occurs between the Y and X electrodes and between the Y and A electrodes. Accordingly, negative (−) wall charges are formed on the Y electrode, and positive (+) wall charges are formed on the X and A electrodes. When the voltage of the Y electrode gradually changes as shown in FIG. 4, a weak discharge occurring in a discharge cell forms wall charges such that a sum of an externally applied voltage and the wall charge may be maintained at a discharge firing voltage. Since every cell has to be initialized in the reset period, the voltage Vset needs to be high enough to fire a discharge in cells of any condition,

In addition, the voltage Vs equals the voltage applied to the Y electrode in the sustain period, and is lower than a voltage for firing a discharge between the Y and X electrodes.

During the falling period of the reset period, the voltage of the Y electrode is gradually decreased from the voltage Vs to a negative voltage Vnf while maintaining the A electrode at the reference voltage. While the voltage of the Y electrode decreases, a weak discharge occurs between the Y and X electrodes and between the Y and A electrodes. Accordingly, the negative (−) wall charges formed on the Y electrode and the positive (+) wall charges formed on the X and A electrodes are eliminated. A magnitude of voltage Vnf is usually set close to a discharge firing voltage between the Y and X electrodes. Then, the wall voltage between the Y and X electrodes becomes near 0V, and accordingly, a discharge cell that has not experienced an address discharge in the address period may be prevented from misfiring in the sustain period. In addition, the wall voltage between the Y and A electrodes is determined by the level of the voltage Vnf, because the A electrode is maintained at the reference voltage.

Subsequently, during the address period for selection of turn-on cells, a scan pulse of a negative voltage VscL, and an address pulse of a positive voltage Va are respectively applied to Y and A electrodes of the turn-on cells. In addition, non-selected Y electrodes are biased at a voltage VscH that is higher than the voltage VscL, and the reference voltage is applied to the A electrode of the turn-off cells (i.e., cells to be turned off). Then, an address discharge is generated in a cell defined by the A electrode that is receiving the voltage Va and the Y electrode that is receiving the voltage VscL, and accordingly, positive (+) wall charges are formed on the Y electrode and negative (−) wall charges are formed on the A electrode and the X electrode. For such an operation, the scan buffer board 230 selects a Y electrode to receive the scan pulse VscL, among the Y electrodes Y1 to Yn. For example, in a single driving method, the Y electrode may be selected according to an order of arrangement of the Y electrodes in the column or vertical direction. When a Y electrode is selected, the address buffer board 210 selects turn-on cells among cells formed on the selected Y electrode. That is, the address buffer board 210 selects A electrodes to which the address pulse of the voltage of Va is applied among the A electrodes A1 to Am.

In more detail, the scan pulse of the voltage VscL is first applied to the scan electrode (Y1 shown in FIG. 2) of a first row, and at the same time, the address pulse of the voltage Va is applied to an A electrode of a turn-on cell in the first row. Then, a discharge is generated between the Y electrode of the first row and the A electrode receiving the voltage Va, and accordingly, positive (+) wall charges are formed on the Y electrode and negative (−) wall charges are formed on the corresponding A and X electrodes. As a result, a wall voltage Vwxy is formed between the X and Y electrodes such that a potential of the Y electrode becomes higher than the potential of the X electrode. Subsequently, the address pulse of the voltage Va is applied to the A electrodes of turn-on cells in a second row while the scan voltage of the voltage VscL is applied to the Y electrode (Y2 shown in FIG. 2) in the second row. Then, address discharge is generated in the cells crossed by the A electrodes that are receiving the voltage Va and the Y electrode in the second row, and accordingly, wall charges are formed in such cells, in a like manner as described above. Regarding Y electrodes in other rows, wall charges are formed in turn-on cells in the same manner described above, i.e., by applying the address pulse of the voltage Va to A electrodes of turn-on cells while sequentially applying a scan pulse of the voltage VscL to the Y electrodes.

In such an address period, the voltage VscL is usually set to be equal to or less than the voltage Vnf, and the voltage Va is usually set to be greater than the reference voltage. Hereinafter, generation of the address discharge by applying the voltage Va to the A electrode will be described in connection with the case that the voltage VscL equals the voltage Vnf. When the voltage Vnf is applied in the reset period, a sum of the wall voltage between the A and Y electrodes and the external voltage Vnf between the A and Y electrodes reaches the discharge firing voltage Vfay between the A and Y electrodes. When the A electrode is receiving 0V and the Y electrode is receiving the voltage VscL(=Vnf) during the address period, the voltage Vfay is formed between the A and Y electrodes, and accordingly a discharge may be expected to be generated. However, in this case, discharge is not generated because a discharge delay is greater than the width of the scan pulse and the address pulse. But if the voltage Va is applied to the A electrode while the voltage VscL(=Vnf) is applied to the Y electrode, a voltage difference that is greater than the voltage Vfay is formed between the A and Y electrodes such that the discharge delay is reduced to less than the width of the scan pulse. Therefore, in this case, discharge may be generated. Also, generation of the address discharge may be facilitated by setting the voltage VscL to be less than the voltage Vnf.

Subsequently, sustain discharge is triggered during the sustain period between the Y and X electrodes by initially applying a pulse of the voltage Vs to the Y electrode because in the cells that have experienced an address discharge in the address period, the wall voltage Vwxy is formed such that the potential of the Y electrode is higher than the potential of the X electrode. In this case, the voltage Vs is set such that it is lower than the discharge firing voltage Vfxy and a voltage value Vs+Vwxy is higher than the voltage Vfxy. As a result of such a sustain discharge, negative (−) wall charges are formed on the Y electrode and positive (+) wall charges are formed on the X and A electrodes, such that the potential of the X electrode is higher than the same of the Y electrode.

Now, since the wall voltage Vwxy is formed such that the potential of the X electrode becomes higher than the potential of the Y electrode, a pulse of a negative voltage −Vs is applied to the Y electrode to fire a subsequent sustain discharge. Therefore, positive (+) wall charges are formed on the Y electrode and negative (−) wall charges are formed on the X and A electrodes, such that another sustain discharge may be fired by applying the voltage Vs to the Y electrode. Subsequently, the process of alternately applying the sustain pulses of voltages Vs and −Vs to the scan electrode Y is repeated a number of times corresponding to a weight value of a corresponding subfield.

As described above, according to the first embodiment of the present invention, reset, address, and sustain operations may be performed by a driving waveform applied only to the Y electrode while the X electrode is biased at the reference voltage. Therefore, a driving board for driving the X electrode is not required, and the X electrode may be simply biased at the reference voltage.

In addition, waveform distortion due to a parasitic component may be prevented since the sustain pulse is applied only to the Y electrode.

As described above, during the falling period of the reset period, the final voltage Vnf applied to the Y electrode is set close to the discharge firing voltage (Vfxy) between the Y and X electrodes. Then, the difference between the wall voltages of the Y and X electrodes becomes substantially 0V, and accordingly, a discharge cell that has not experienced an address discharge in the address period may be prevented from misfiring in the sustain period. However, the discharge firing voltage (Vfay) between the Y electrode and the A electrode is lower than the discharge firing voltage (Vfxy) between the Y electrode and the X electrode. Therefore, all the wall charges formed between the Y electrode and the A electrode are substantially removed before reaching the final voltage Vnf in the falling period. Subsequently, wall charges having polarities opposite to the polarity of the applied voltage are formed such that the potential of the Y electrode due to the wall charges will become higher than the potential of the A electrode. That is, positive (+) wall charges and negative (−) wall charges may be respectively formed on the Y electrode and the A electrode at the final voltage (Vnf) of the falling period. The discharge cells that have not experienced an address discharge in the address period, may maintain the wall charges resulting from the falling period voltages. These wall charges may cause a sustain discharge in the cells during the sustain period even though the cells were not addressed to be discharged. In other words, when the voltage Vs is applied to the Y electrode during a sustain period, a misfire may occur between the Y electrode and the A electrode of a discharge cell which has not experienced an address discharge in the address period. This misfire occurs because, as described above, the positive (+) wall charge of the Y electrode with respect to the A electrode may be set at the final voltage (Vnf) of the falling period, and the discharge cell that has not experienced an address discharge in the address period can maintain such a positive wall charge.

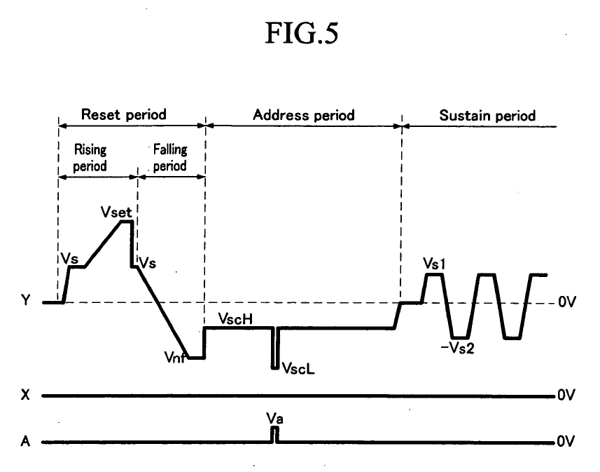

Referring to FIG. 5, a method will be described for preventing such a misfire that is generated by the application of the voltage Vs during the sustain period in the first exemplary embodiment of the present invention.

FIG. 5 is a driving waveform diagram of a plasma display device according to a second exemplary embodiment of the present invention.

As shown in FIG. 5, a driving waveform according to the second exemplary embodiment of the present invention is the same as the driving waveform according to the first exemplary embodiment of the present invention except that a sustain pulse alternately having the voltage Vs1 and −Vs2 is applied to the Y electrode during the sustain period. A magnitude of voltage Vs1 (i.e., |Vs1|) is smaller than the magnitude of voltage −Vs2 (i.e., |−Vs2|), and the voltage Vs1 is smaller than the voltage Vs of the first exemplary embodiment of the present invention. In addition, the voltage −Vs2 is set to be equal to or less than the voltage −Vs of the first exemplary embodiment of the present invention. When the difference between the voltage Vs1 and the voltage −Vs2 is maintained at the level of the voltage 2Vs, then |Vs1| may be set to be smaller than |-Vs2|.

As shown in FIG. 5, if a magnitude of voltage Vs1 is set to be smaller than that of voltage Vs of the first exemplary embodiment, the voltage difference (|Vs1-0V|) between the Y electrode and the A electrode becomes smaller when the voltage Vs1 is applied in the sustain period than when the voltage Vs is applied. Accordingly, misfiring between the Y electrode and the A electrode can be prevented. That is, since the voltage of the sustain pulse that is applied to the Y electrode in the sustain period is lowered from the voltage Vs to the voltage Vs1, a misfiring between the Y electrode and A electrode can be prevented when the voltage Vs is applied to the Y electrode in the sustain period. At this time, the magnitude of voltage Vs1 is appropriately determined by an experimental method such that the discharge cell selected in the address period may generate the sustain discharge in the sustain period, and so the discharge cell not selected in the address period may not misfire in the sustain period.

In addition, the voltage −Vs2 is set to be higher than the voltage Vnf. Since the discharge cell not selected in the address period maintains the wall charge at the end of the reset period, the discharge cell not selected in the address period may misfire in the sustain period when the voltage −Vs2 is lower than the voltage Vnf. Therefore, when the voltage −Vs2 is set to be higher than the voltage Vnf, misfiring in the sustain period can be prevented. In addition, when the voltage −Vs2 is set to be equal to or less than the voltage −Vs, stable discharges can be maintained as in the first exemplary embodiment.

However, in the second exemplary embodiment of the present invention, when the voltage Vs1 is set to be lower than the voltage Vs, a weak discharge in the sustain period can be generated at the discharge cell selected in the address period. More particularly, compared to the discharge cell selected later in the address period, the discharge cell selected earlier in the address period includes smaller amounts of the wall charges and priming particles. Accordingly, an occurrence rate of the low discharge can be significantly increased in the sustain period. Hereinafter, a driving method for preventing such a low discharge will be described in detail.

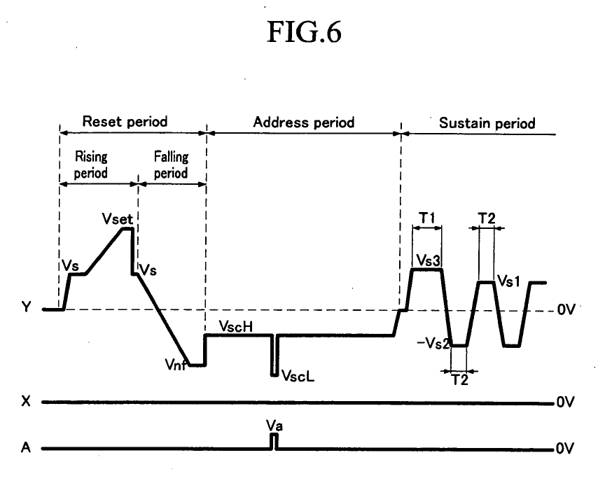

FIG. 6 is a driving waveform diagram of a plasma display device according to a third exemplary embodiment of the present invention.

As shown in FIG. 6, a driving waveform according to the third exemplary embodiment of the present invention is the same as the driving waveform according to the second exemplary embodiment of the present invention except that the first sustain pulse applied to the Y electrode in the sustain period includes the voltage Vs3 which is higher than Vs1 of the second exemplary embodiment.

First, the first sustain pulse applied to the Y electrode includes the voltage Vs3 which is higher than the voltage Vs1. Accordingly, since stable sustain discharge can be generated by preventing elimination of wall charges and priming particles in the address period, the problem of the low discharge can be prevented. Subsequently, the sustain pulse applied to Y electrode, like the sustain pulse in the second exemplary embodiment, includes the voltage −Vs2 and the voltage Vs1 alternately. Since the sustain pulse first applied to the Y electrode includes the voltage Vs3 which is higher than the voltage Vs1, the stability of the sustain discharge that is first generated in the sustain period can be ensured. Accordingly, the wall charge and priming particles with respect to the discharge cell selected in the address period can be ensured due to the stability of the first sustain discharge. Therefore, since more stable discharges can be ensured in the subsequent sustain discharges, the problem of low discharge can be prevented.

In addition, in order to further ensure the stability of the first sustain discharge, the width T1 of the first sustain pulse can be set wider than the width T2 of the second sustain pulse. In the case that the width of the sustain pulse is extended, since the time for generating the discharges and for accumulating the wall charges can be further ensured, more stable sustain discharges can be generated. Consequently, the problem of the low discharge can be prevented.

Even though FIG. 6 denotes that only the first sustain pulse has the voltage Vs3 and the width of T1, a plurality of sustain pulses other than the first sustain pulse may also have the voltage Vs3 and the width of T1. Therefore, the problem of the low discharge can be further prevented.

In addition, even though FIG. 6 denotes that the first sustain pulse applied to the Y electrode includes both characteristics of the voltage Vs3 and the width of T1, it may include only one of the characteristics. For example, the voltage Vs3 having the width of T2 or the voltage Vs1 having the width of T1 may be used instead.

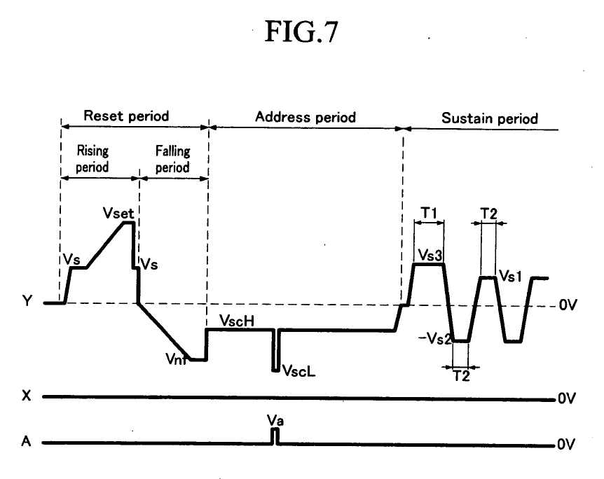

As shown in FIG. 6, the voltage applied to the Y electrode is gradually decreased from the voltage Vs to the voltage Vnf during the falling period of the reset period. Since the voltage Vnf of the Y electrode is nearly the same as the discharge firing voltage between the Y electrode and X electrode, the gradient of the voltage in the falling period is large and the voltage may be sharply decreased over the duration of the falling period. Generally, when the voltage applied at the electrode is slowly reduced with time, weak discharge is generated more frequently. However, when the gradient of the voltage in the falling period is large and the voltage is being rapidly decreased as shown in FIG. 6, a strong discharge can be generated in the falling period, and the contrast ratio may deteriorate due to the strong discharge. A driving method for preventing the deterioration of the contrast ratio will be described with reference to FIG. 7.

FIG. 7 is a driving waveform diagram of a plasma display device according to a fourth exemplary embodiment of the present invention.

As shown in FIG. 7, when the voltage of the Y electrode is gradually decreased in the falling period of the reset period from a voltage lower than the voltage Vs, the voltage applied at the Y electrode can be slowly reduced with time and the voltage drop has a smaller gradient. Therefore, the occurrence of the strong discharge in the falling period of the reset period can be prevented. When the voltage applied at the Y electrode is set to be 0V, additional power sources may not be required. For example, when the voltage applied at the Y electrode starts to be reduced from 0V, both the difference between the voltages applied to the X electrode and Y electrode and the difference between the voltages applied to the A electrode and Y electrode are 0V at the starting point of reduction of the voltage applied to the Y electrode in the falling period. Therefore, the occurrence of the strong discharge can be prevented. Thereafter, when the voltage applied to the Y electrode is gradually decreased from 0V, weak discharge can be generated if the difference between the wall charge formed in the cell and the voltage applied from the outside is greater than the discharge firing voltage. Consequently, the wall charge may be changed due to the weak discharge.

As described above, according to an exemplary embodiment of the present invention, the reset period of each subfield includes the rising period and the falling period. On the other hand, the reset period of some subfields may include only the falling period. In the subfields including the reset period composed of only the falling period, only the cell in which the sustain discharge is generated in the immediately prior subfield can be initialized or reset. The cell in which the sustain discharge is not generated in the immediately prior subfield cannot be initialized again because it maintains the status of the wall charge initialized in the reset period of the immediately prior subfield.

As described above, according to an exemplary embodiment of the present invention, while the sustain electrode is biased at a predetermined voltage, the driving waveform is applied to only the scan electrode. Therefore, a plasma display device can be actually driven by using only a single board. Consequently, the area on the chassis base occupied by the driving boards can be reduced, and the total manufacturing cost of circuits used for driving a PDP can also be reduced.

In addition, since the voltage level of the sustain pulse that is applied to the scan electrode in the sustain period can be lowered according to the second embodiment of the present invention, the misfiring in the sustain period can be prevented. In addition, the low discharge in the sustain period can be prevented by setting the voltage level of the sustain pulse first applied to the electrode to be high or by setting the width of the first sustain pulse to be wider.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display device during a frame divided into a plurality of subfields, the plasma display device having a plurality of first electrodes and a plurality of second electrodes, the method comprising, in a sustain period of at least one subfield among the plurality of subfields:
biasing the first electrode at a reference voltage;
applying to the second electrode at least once during a first part of the sustain period a first sustain pulse having a voltage of a first magnitude; and
alternately applying to the second electrode during a second part of the sustain period a second sustain pulse and a third sustain pulse,
wherein the second sustain pulse has a voltage of a second magnitude, the second magnitude being smaller than the first magnitude,
wherein the third sustain pulse has a voltage of a third magnitude, the third magnitude being greater than the second magnitude, and
wherein the second part follows the first part.

2. The method of claim 1, wherein a width of the first sustain pulse is greater than a width of the second sustain pulse and greater than a width of the third sustain pulse.

3. The method of claim 1, wherein the voltage of the first sustain pulse is higher than the voltage of the second sustain pulse.

4. The method of claim 3, wherein the voltage of the second sustain pulse is higher than the reference voltage, and the voltage of the third sustain pulse is lower than the reference voltage.

5. The method of claim 4, wherein the first sustain pulse, the third sustain pulse, and the second sustain pulse are sequentially applied to the second electrode with the first sustain pulse preceding the third sustain pulse and the third sustain pulse preceding the second sustain pulse.

6. The method of claim 1, further comprising during a reset period of the at least one subfield:
gradually decreasing a voltage of the first electrode from a second voltage to a third voltage, the third voltage being lower than the voltage of the third sustain pulse.

7. The method of claim 1, wherein the reference voltage is a ground voltage.

8. A plasma display device, comprising:
a plasma display panel including a plurality of first electrodes and a plurality of second electrodes, the plasma display panel being driven during frames divided into subfields, each subfield including a reset period and a sustain period; and
a driver for applying sustain pulses to the second electrode while biasing the first electrode at a first voltage during a sustain period of at least one subfield,
wherein the driver applies to the second electrode at least once during a first part of the sustain period a first sustain pulse having a first pulse width, and
wherein the driver alternately applies to the second electrode during a second part of the sustain period a second sustain pulse and a third sustain pulse, the second sustain pulse having a second pulse width being smaller than the first pulse width, the second sustain pulse having a second voltage being lower than the first voltage, the third sustain pulse having a third pulse width being smaller than the first pulse width, and the third sustain pulse having a third voltage being higher than the first voltage,
wherein a magnitude of the third voltage is smaller than a magnitude of the second voltage, and
wherein the second part follows the first part.

9. The plasma display device of claim 8, wherein the first sustain pulse is first applied to the second electrode during the sustain period.

10. The plasma display device of claim 8, wherein the driver gradually decreases a voltage of the second electrode from a fourth voltage to a fifth voltage during a reset period of the at least one subfield, the fifth voltage being lower than the second voltage.

11. The plasma display device of claim 8, wherein the first voltage is a ground voltage.

12. The plasma display device of claim 8, wherein the second pulse width is the same as the third pulse width.
